(19) United States
(12) Patent Application Publication
(10) Pub. No.: US 2008/0199751 A1
(43) Pub. Date: Aug. 21, 2008

(54) Bipolar plate for an air breathing fuel cell stack

(75) Inventors: Sarbjit Singh Giddey, Glen Waverley (AU); Fabio T. Ciacchi, Clayton (AU); Sukhvinder P.S. Badwal, Clayton (AU)

Correspondence Address: LAHIVE & COCKFIELD, LLP, ONE POST OFFICE SQUARE, BOSTON, MA, 02109, US

(73) Assignee: Commonwealth Scientific and Industrial Research Organisation, Campbell (AU)

(21) Appl. No.: 11/708,392

(22) Filed: Feb. 20, 2007

(51) Int. Cl. H01M 8/10

(52) U.S. Cl. 429/30

(57) ABSTRACT

A bipolar interconnect plate for a fuel cell, including: a first surface having a series of conductive interconnect posts for forming a conductive interconnect for conductively interconnecting, in use, with a cathode surface of a MEA; the plate including a series of ridges surrounding the first surface having air access slots therein in fluid communication with the first surface.

### FIELD OF THE INVENTION

The present invention is directed to the field of bipolar plates for use in Fuel Cells or the like and, in particular, discloses a self air breathing bipolar plate design.

### BACKGROUND OF THE INVENTION

A fuel cell is an electrochemical device that converts chemical energy of a fuel (such as hydrogen or methanol) and oxidant (oxygen from air) into electrical energy and heat. The fuel cell has all the attributes of a battery, except that a fuel cell continues to produce electricity as long as fuel and oxidant are available, as opposed to a battery that stops producing power when the stored chemicals are exhausted. Several different types of fuel cells are under development. Amongst these, polymer electrolyte membrane (PEM) fuel cell is regarded as the most suitable technology for transport and small scale distributed power generation applications, because they operate at low temperatures (70-80° C.) and offer rapid start and shut down operation, unlimited thermal cycling capability and excellent load following characteristics. Around 50% of the power is available at cold start. A conventional polymer electrolyte membrane fuel cell stack consists of a number of cells called membrane electrode assemblies (MEAs) connected in series with the help of interconnect (bipolar middle and unipolar end ones) plates to produce the required stack voltage and power. Each cell (or MEA) consists of a proton conducting polymer membrane sandwiched between a hydrogen (anode) electrode and an oxygen (cathode) electrode. The interconnect plates serve dual purpose: to electrically connect one cell to the other (to conduct electrical current) and to distribute reactants (as well collect products) to (from) the respective electrodes of the MEAs. Hydrogen and air (source of oxygen) are supplied to the electrodes via flow field gas channels in the interconnect plates. On shorting the cell (or stack) through an external load hydrogen supplied to the anode gets oxidised to protons and electrons. Electrons travel through the external load and protons are transported through the membrane to the cathode, where they react with the oxygen supplied to cathode side and electrons from the external load to produce water as per following reactions.

At anode (Hydrogen electrode): H₂=2H⁺+2e

At cathode (Air electrode): 2H⁺+½O₂+2e=H₂O

The oxygen depleted air along with the water formed on the air side of the MEA electrodes are collected by the gas flow channels. The air supplied to the oxygen electrode in addition to supplying oxygen, also helps in the removal of water formed at the electrode and thereby uncovering the reaction sites for more oxygen (air) access for the reaction. The voltage from a single cell under load conditions is in the range of 0.4 to 0.8V DC and current densities in the range 100 to 700 mA.cm⁻².

In case of micro fuel cells for portable power applications, the fuel cell system is required to be smaller, simpler (without or less moving parts) and easily manufacturable at a mass scale. This is where the concept of self air breathing (no air compressors for oxygen supply to fuel cell), passive operation (no moving parts), miniaturisation of components (interconnects, micro fluid flow channels, overall system) and cheap fabrication methods have to be introduced to compete with batteries. There are two main configurations—stacking arrangement and planar or flat plate array design. In the planar configuration, the individual cells are laid flat side by side in a single plan, and oxygen (air) electrode side active area of each cell is exposed to atmospheric air for oxygen, and for water and heat exchange with the atmosphere. In a planar configuration series connections have to be established between individual cells with the negative of one cell connecting to the positive of the next cell on the other side of the array. In the stacking configuration, the cells are stacked one over the other with the help of bipolar interconnect plates. This simplifies connections between cells, however, it becomes difficult to provide atmospheric access to air side electrodes of the stack in a passive operation with no external air compressors. The stacking is generally used for bigger size fuel cell units (>10-20 Wₑ range). In a stacked configuration, the series connection between one cell to the next cell is in-built as the interconnect plate between any two cells acts as a bipolar plate and therefore, no special connections are required to be made between the cells. Secondly, the resistive losses due to connections between cells are expected to be very low as the contact area between cells is significantly higher (basically it's the resistance of the bipolar plate across its thickness).

Conventional fuel cells require the supply of compressed air to the oxygen electrode of the fuel cell to supply oxygen and to remove water produced by the electrochemical reaction. This increases the complexity of the system in portable power applications. However, if the oxygen electrode of each fuel cell in the assembled stack can be exposed to atmospheric air, the cells can self breath oxygen from the atmosphere. This requirement can be achieved by horizontal placement of cells in a planar configuration, whereby all the respective oxygen electrodes of cells are on one side and hydrogen electrodes are on the other side. However, planar array designs are limited to low overall power output due to limitations on the fuel cell area that needs to be exposed to air. Therefore, for higher power output (e.g. above 20-30 Wₑ), stacking configuration would be more appropriate. A stacked design offers substantial flexibility in terms of the electrode area and the number of cells that can be stacked (connected in series). The challenge, however, is how to expose oxygen electrode side of each of the cells in the stack to oxygen in atmospheric air without utilising a forced air supply thus combining the features of stacked configuration in a self air breathing compact design.

Examples of air breathing fuel cells exist in the prior art. For example, U.S. Pat. Nos. 4,407,904 to Uozum et al, 4,977,041 to Siozawa et al, 5,508,128 to Akagi, 6,218,035 to Fuglevand et al disclose air breathing fuel cell arrangements, the contents of which are hereby incorporated by cross reference.

### SUMMARY OF THE INVENTION

It is an object of the present invention to provide an improved form of air breathing fuel cell arrangement.

In accordance with a first aspect of the present invention, there is provided a bipolar interconnect plate for a fuel cell, including: a first surface having a series of conductive interconnect posts for forming a conductive interconnect for conductively interconnecting, in use, with the cathode (air or oxygen) surface; the plate including a series of ridges surrounding the first surface having air access slots therein in fluid communication with the first surface.

The second surface of the plate preferably can include a series of fuel supply channels formed therein, the fuel supply channels mating with an anode surface in use to supply a fuel to the surface of the anode. Preferably, side ridges surround the first surface for, in use, forming a seal against a membrane surface.

The plate preferably can include a series of apertures for the transmission of fluid there through. The plate can be formed from fine grain graphite impregnated with a resin. The plate can be formed from a metal that has been processed by means of at least one of electoetching, electroplating, stamping or embossing.

Ideally, the plates are used in a mutltiplate fuel cell stack, each interposed and interconnected to a membrane electrode assembly. The fuel cell can be arranged in a stacked configuration. In one embodiment, the air can be fan fed to the fuel cell using power from the fuel cell.

In some embodiments, the plate can be formed from two sub plate joined together. The joining of the two sub plates are preferably joined together by one of spot welding, or using electrically conducting adhesives or glues. Pins or nails are preferably utilised to form a conductive interconnect between the subplates. Several portions of the plate are preferably fabricated separately and joined to form the interconnect plate.

Preferably, the plate can be formed from a metal that has corrosion protection coating. The plate can be utilised in a multi cell fuel cell array and preferably can include a multi cell interconnect where two or more cells are preferably interconnected in a planar arrangement and subsequently stacked with a number of such planar cell arrays. The conductive interconnect posts can have a cross section that can be one of rectangular, circular, hexagonal, elliptical, octagonal. The air access slots are preferably of different shapes. The interconnect plate also acts as a current collection plate.

### BRIEF DESCRIPTION OF THE DRAWINGS

Benefits and advantages of the present invention will become apparent to those skilled in the art to which this invention relates from the subsequent description of exemplary embodiments and the appended claims, taken in conjunction with the accompanying drawings, in which:

FIG. 1 illustrates schematically an air breathing fuel cell constructed in accordance with the teachings of the preferred embodiment;

FIG. 2 illustrates the hydrogen flow channels of the bipolar plate;

FIG. 3 is a side perspective view of the oxygen/air side of the bipolar plate;

FIG. 4 is a plan view of the oxygen/air side of the bipolar plate;

FIG. 5 is a plan view of the current collector plate;

FIG. 6 is a side perspective view of the current collector plate;

FIG. 7 is a plan view of the stack assembly plate;

FIG. 8 is a side perspective view of the stack assembly plate;

FIG. 9 is a side perspective view of portions of a fuel cell arrangement;

FIG. 10 is a side perspective view of portions of a fuel cell arrangement;

FIG. 11 is a photograph of an assembled fuel cell arrangement of the preferred embodiment;

FIG. 12 is a graph of the typical voltage current characteristics of a fuel cell stack;

FIG. 13 illustrates example lifetime performance of a fuel cell stack;

FIG. 14 is a plan view of the air breathing side and edges of an alternative bipolar plate;

FIG. 15 illustrates a plan view of the hydrogen side of an alternative bipolar plate arrangement;

FIG. 16 illustrates a side perspective view of the oxygen/air breathing side of an alternative bipolar plate arrangement; and

FIG. 17 is a graph illustrating the fuel cell performance difference of different bipolar plate designs.

### DESCRIPTION OF THE PREFERRED AND OTHER EMBODIMENTS

The preferred embodiments provide the ease of series connection using bipolar interconnects (where two adjoining MEAs sandwich a bipolar interconnect plate) with a self air breathing concept of micro fuel cells to construct fuel cell stacks from a few watt to several hundred watts. The bipolar interconnect design of the preferred embodiment has been developed to provide oxygen access from atmospheric air to oxygen electrode of each cell in a fuel cell stack. It consists of an electrically conducting plate with hydrogen flow channels on one side and ‘pillar and land’ design on the other side. The pillars provide the electrical contact with the oxygen electrode of membrane electrode assembly (MEA), and lands (open areas) exchange oxygen and water with the atmospheric air through a series of slots on the periphery of the interconnect plate. By controlling the size and number of lands and pillars, fluid flow, current and heat distribution can be optimised in the stack. Compact packaging of a large number of cells (large effective surface area) is possible due to stacked configuration, avoiding the surface area limitations of the planar design.

The design permits the self management of excess heat (dissipation to atmosphere) and water as well as allowing effective membrane humidification. Manifolding and sealing is also very simple. In this design, in addition, a micro chip fan, driven by the fuel cell stack power, can be incorporated for forced air flow which further increases the power density available from the stack and allows even more effective heat and water management. This design extends air breathing concept to stacking of single cells thus allowing easy construction of 10-500 Wₑ small fuel cell systems while still keeping a compact overall size.

There are number of variations possible in design variables of this interconnect such as pillar dimensions, pillar-to-land ratio, cell active area-to-air access slot ratio etc., which can be optimised to cater for the particular application and power requirements of the device.

The design of the preferred embodiment of a bipolar interconnect plate allows oxygen (from atmospheric air) access to the oxygen electrode of each cell of the stack, making it possible to realise a self air breathing fuel cell device in a stacked configuration. The ‘lands and pillars’ design of the air side of the interconnect allows full control on the size and number of lands and pillars for optimisation of the fluid flow (air/oxygen circulation), current and heat distribution in the stack. The design of the preferred embodiment permits the self management of excess heat (dissipation to atmosphere) and water as well as allowing effective membrane humidification. Compact packaging of a large number of cells (large effective surface area) is therefore possible due to stacking configuaration, avoiding the surface area limitations of the planar design. In this design, in addition, a stack voltage driven micro chip fan can be incorporated for forced air flow which further increases the power density available from the stack and allows even more effective heat and water management. Manifolding and sealing is also very simple. The design extends air breathing concept to stacking of single cells thus allowing easy construction of 10-500 Wₑ, small fuel cell systems while still keeping the overall size fairly compact without forced air supply thus combining the good features of stacked configuration in a self air breathing compact design.

The preferred embodiment allows a series connection using bipolar interconnects (where two adjoining MEAs sandwich a bipolar interconnect plate) with the self air breathing concept of micro fuel cells to construct fuel cell stacks from a few watt to several hundred watts. The design has been demonstrated in the 10-50 Wₑ power range stacks with and without a stack voltage driven fan. However, the design can be scaled up for higher power outputs, in the 100-500 Wₑ range. This design can also be used in combination with a planar configuration, for example 4 cells assembled in a planar arrangement on a single multi cell interconnect, and stacked with a number of such 4-cell planar arrangements. This type of multi array, parallel cell design would have built-in redundancy in the case of a cell failure in the array.

The bipolar interconnect plate designed in accordance with the principles of the preferred embodiment was initially constructed in exemplary form by construction and assembly of a 6 cell self air breathing polymer electrolyte membrane (PEM) fuel cell stack.

### Stack Design

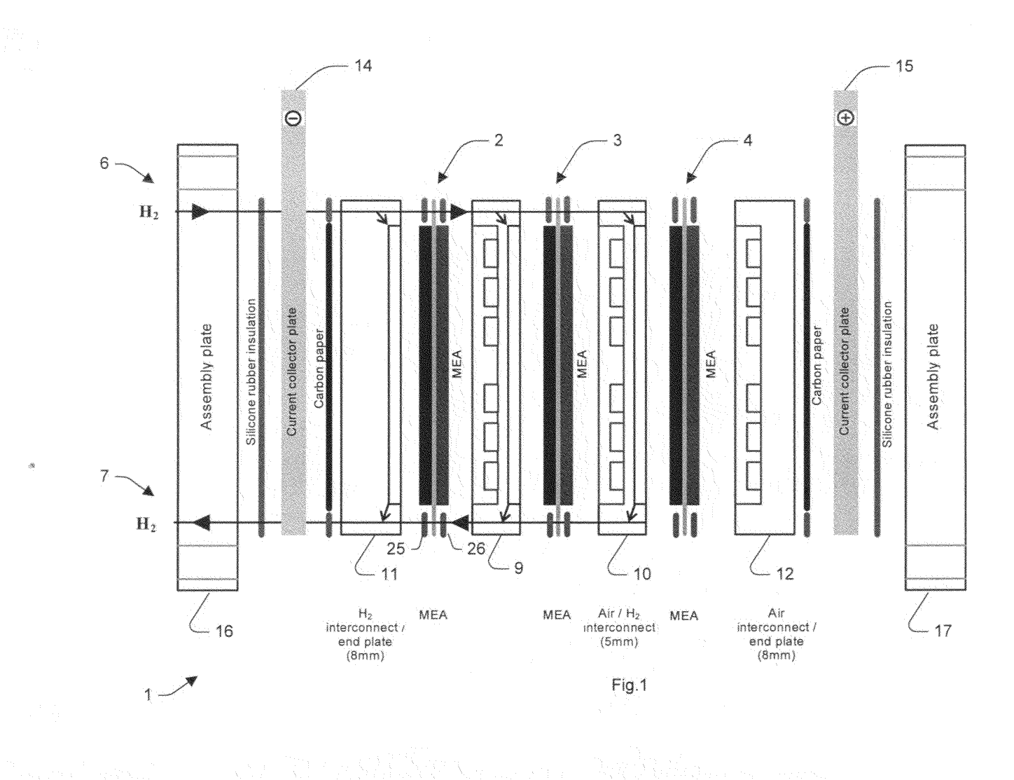

FIG. 1 shows the schematic diagram of a self air breathing PEM fuel cell stack 1. The figure shows the major components and their respective locations in the stack. In the diagram for simplicity, only three membrane electrode assemblies (MEAs) 2-4 are shown, but the actual stack was constructed using six MEAs. The figure also shows the hydrogen gas manifolding, consisting of gas distribution 6 and gas collection ports 7 (4 mm diameter) for supply and collection of reactants/products.

As a variation of the above design, there can be any number of other MEAs in the stack, and there could be a different design of the gas manifolding for distribution (fuel) and collection of spent fuel, water and/or other products. The stack can also be used for any other fuel such as methanol, ethanol etc.

### Bipolar Interconnect Plates 9, 10

An interconnect plate of an assembled self air breathing fuel cell stack is designed in such a way that oxygen electrode of each cell has an access to the atmosphere for oxygen, and heat and water exchange. The bipolar plates 9,10 were constructed using fine grain graphite impregnated with a resin. However, as a variation of the above, the plate can be fabricated from a metal or an alloy that does not corrode or any metal (or alloy) with a corrosion resistant coating. The overall dimensions of the interconnect plates 9,10 for the six cell stack were 6 mm×60 mm×60 mm. As a variation, the dimensions (thickness and size) and shape (circular, square, hexagon, octagon, etc) of the interconnect plate can be different, as determined by the active area of each cell, gas manifolding design, heat distribution in the stack, and shape and size of the appliance (application). Interconnect bipolar plates for the six cell stack were fabricated by CNC machining.

Other methods for constructing the bipolar plates can be utilised. As a variation, the complete interconnect plate or some of the features can be fabricated using other technologies such as electroetching, electroplating, stamping, embossing etc. Instead of using a single block of material to fabricate both air and fuel side flow fields, there can be two separate plates fabricated—one with hydrogen flow field and the other with air flow field, and these plates are joined together with flow fields opposing each other. The joining of the two plates can be carried out by methods such as spot welding, or using electrically conducting adhesives or glues. Also where conducting adhesive are not used pins or nails may be used to make electrical contact between various components. In another variation several components fabricated separately may be joined as described above to form the interconnect plate. The end plates 11, 12 can be constructed in a similar manner but will only include one surface profile (Air or Hydrogen Profile) as required.

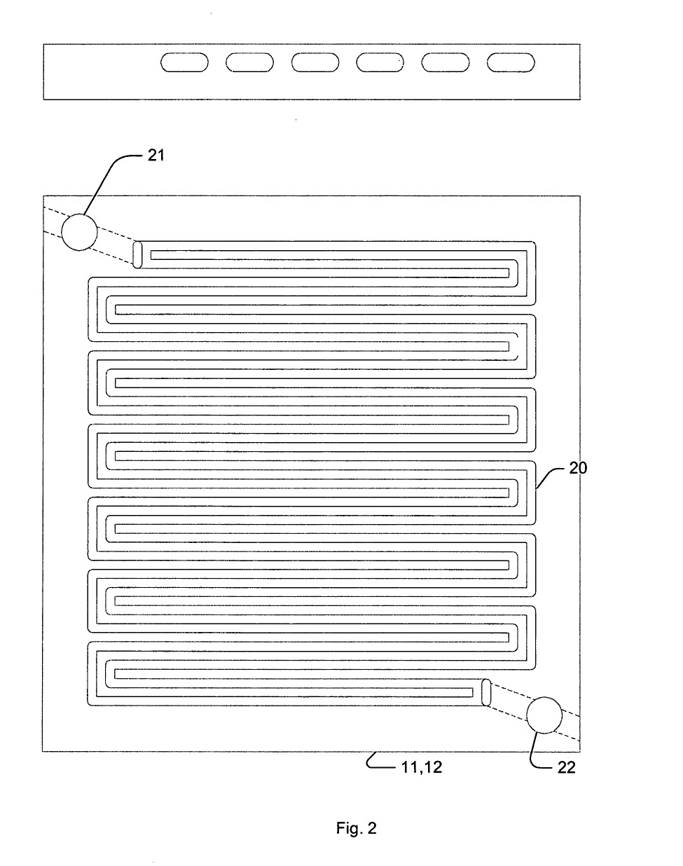

Hydrogen flow field: As illustrated in FIG. 2, for the six cell stack, hydrogen flow field was as illustrated in consisted of a serpentine flow field of double parallel channels and ribs, in the active area, in a cross sectional area of 50 mm×50 mm. There were 26 channels, each of width 1 mm and depth 1 mm, and 25 ribs, each of thickness 1 mm and height 1 mm. In a design variation, the number of serpentine flow channels may be more than two and the number of ribs and channels and channel shape and depth may vary accordingly. A number of other design variations are possible for fuel distribution channels. For the six cell stack, the main hydrogen inlet and exit ports (4 mm diameter through holes) 21, 22 connected to the flow field were positioned at diagonally opposite corners i.e. the gas enters at one corner 21 and after traversing through the entire serpentine flow field it exits the other corner 22. An extra area was provided near the inlet 21 and exit ports 22 (where there is no flow field) for sufficient sealing by the gasket. As a variation to the above flow field design, the inlet and outlet ports for the fuel may be positioned at different locations. In another variation, the flow channel and rib dimensions and shapes may be different.

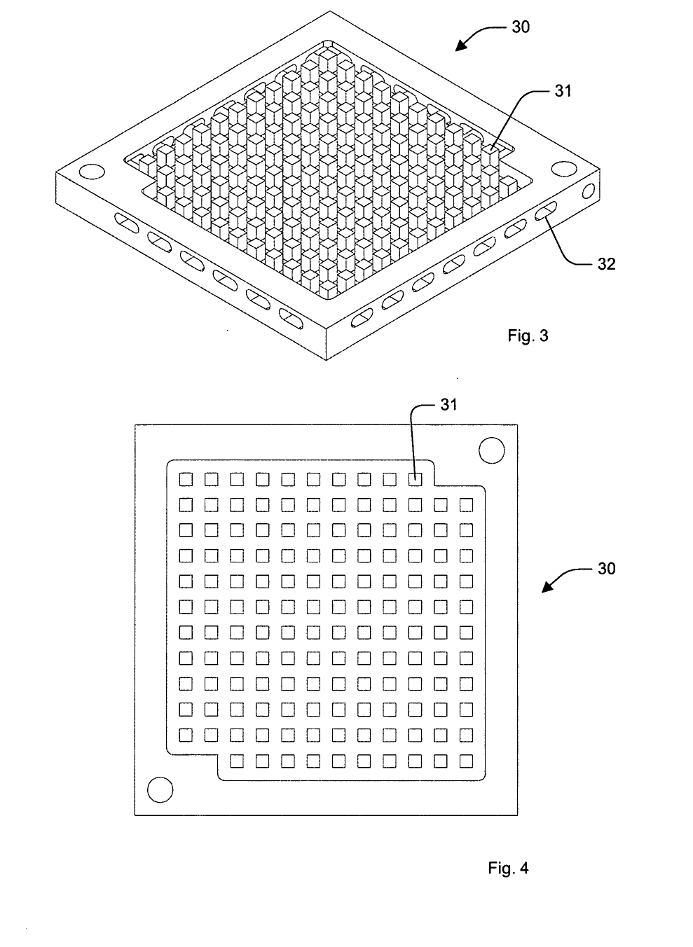

Airflow field: The air flow field is illustrated in FIG. 3 and FIG. 4, with FIG. 3 illustrating a side perspective view and FIG. 4 illustrating a top plan view of the flow field 30. Air flow field consists of a ‘pillar and land’ design. There are 12 rows and 12 columns of 2 mm×2 mm cross-section and 3 mm high pillars e.g. 31 in a cross sectional area of 50 mm×50 mm. The pillars are 2 mm apart from each other, and the space between these forms a ‘land’ part of the flow field. The pillars provide the electrical contact with the oxygen electrode of membrane electrode assembly (MEA), and lands exchange oxygen and water with the atmospheric air through a series of slots e.g. 32 on the periphery of the interconnect plate. There are six slots on two opposite sides and seven on the other two. Each slot 32 is of a generally rectangular shape with shorter sides having 1 mm radius and having an overall 5.3 mm width (3 mm straight portion and 1 mm radius on each side) and 2 mm thickness. By controlling the size and number of lands and pillars, fluid flow, current and heat distribution can be optimised in the stack. As a variation to the square shaped pillars and rectangular slots for air breathing, the pillars can be rectangular or circular and instead of slots there can be circular holes for self air breathing.

Compact packaging of a large number of cells (large effective surface area) is possible due to stacking configuration, avoiding the surface area limitations of the planar design. This design permits the self management of excess heat (dissipation to atmosphere) and water as well as allowing effective membrane humidification. Manifolding and sealing is also very simple. In this design, in addition, a stack voltage driven micro chip fan can be incorporated for forced air flow which further increases the power density available from the stack and allows even more effective heat and water management. There are number of design variables of this interconnect such as pillar dimensions, pillar-to-land ratio, cell active area-to-air access slot ratio etc., which can be further optimised to cater for the application and power requirements of the device.

### Current Collector Plates (14, 15 of FIG. 1)

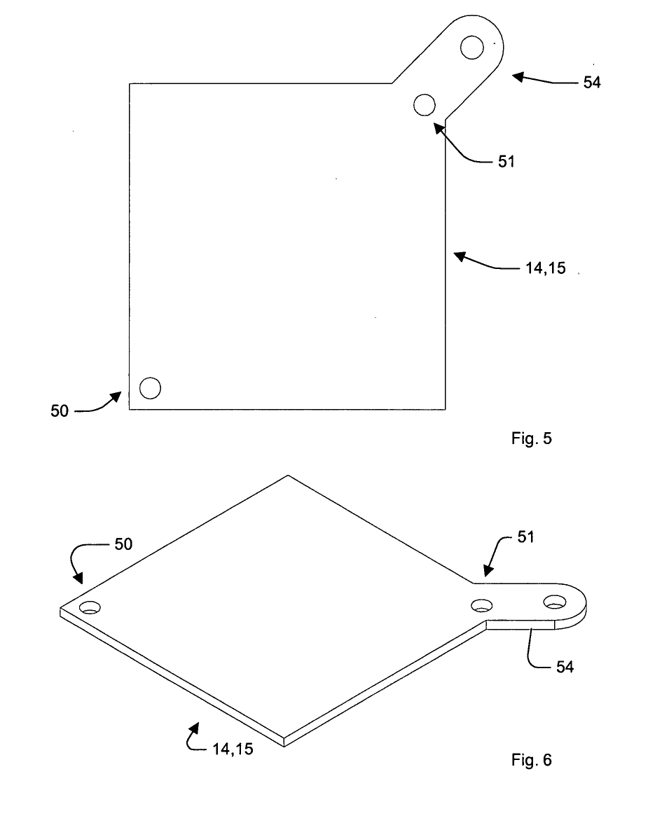

Returning initially to FIG. 1, for the six cell stack, nickel electroplated copper plates of thickness 3 mm and cross section 60 mm×60 mm are used as current collector plates 14, 15 for the stack. Other metals may also be used. FIG. 5 and FIG. 6 illustrate the plates in more detail. The diagonal 4 mm diameter holes 50, 51 in the plate form part of the hydrogen gas distribution ports, and the extended tab 54 is used for making electrical connections of the stack to the electrical load.

As a variation interconnect plates at both ends of the stack can be used as interconnects as well as current collector plates. These plates would have extended tabs for electrical connection to the electrical load. This will avoid the use of additional current collector plates.

### Assembly Plates (16, 17 of FIG. 1)

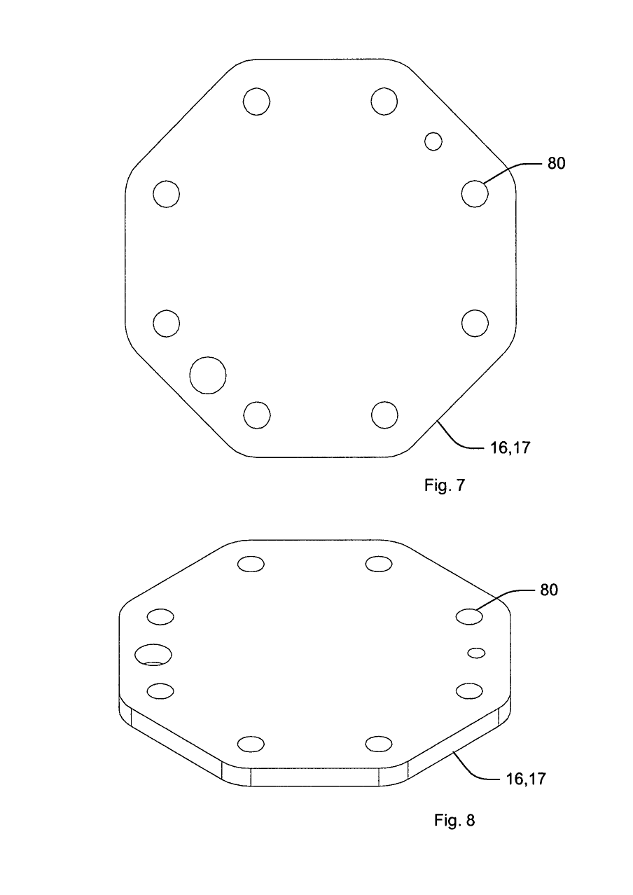

Titanium plates of thickness 4 mm have been used as stack assembling plates 16, 17. FIG. 7 and FIG. 8 illustrate plan and perspective views of the plates 16, 17 respectively. Titanium is used to provide enough toughness but keeping the stack light in weight. The plates are of octagonal shape, again to reduce the overall weight of the stack. There are eight through holes (diameter 6 mm) in the plate e.g. 80, used for assembling the stack with the help of ‘all threaded’ tie rods (diameter 5 mm).

### Insulation and Sealing (25, 26 of FIG. 1)

In order to prevent any leakage of hydrogen gas from hydrogen compartment to atmosphere or air side of the MEAs, silicone rubber gaskets 25, 26 were used in the stack assembly.

### Stack Assembly

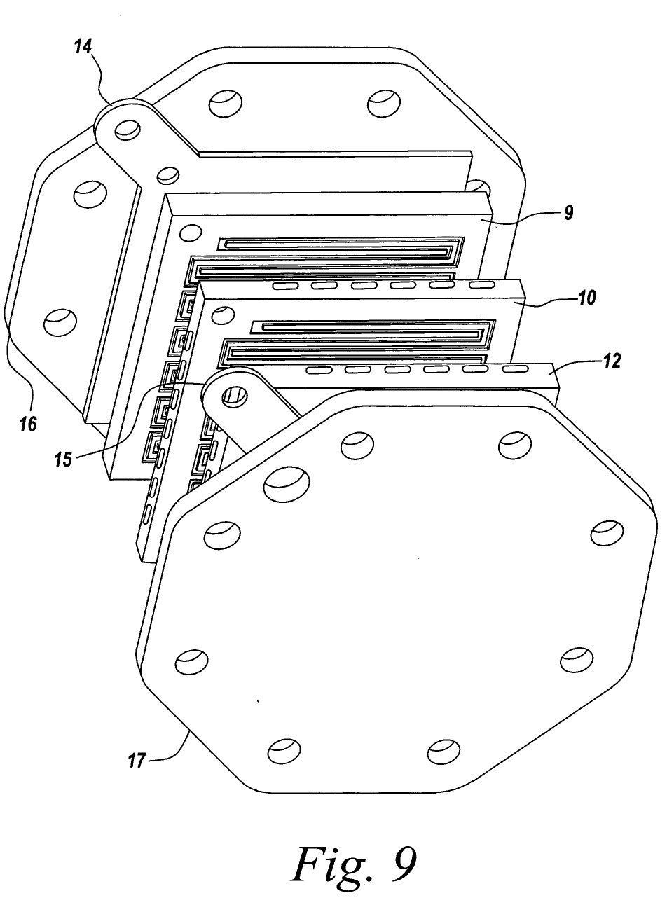

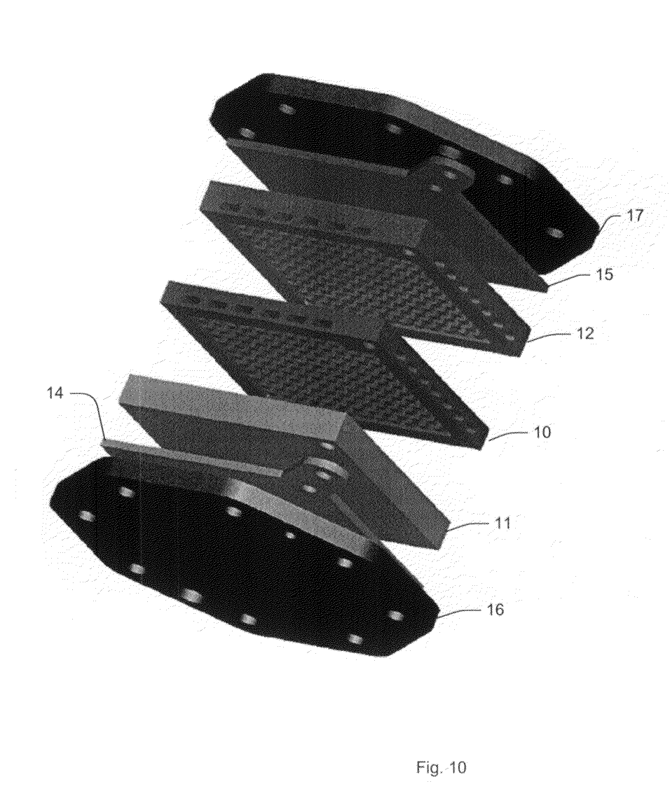

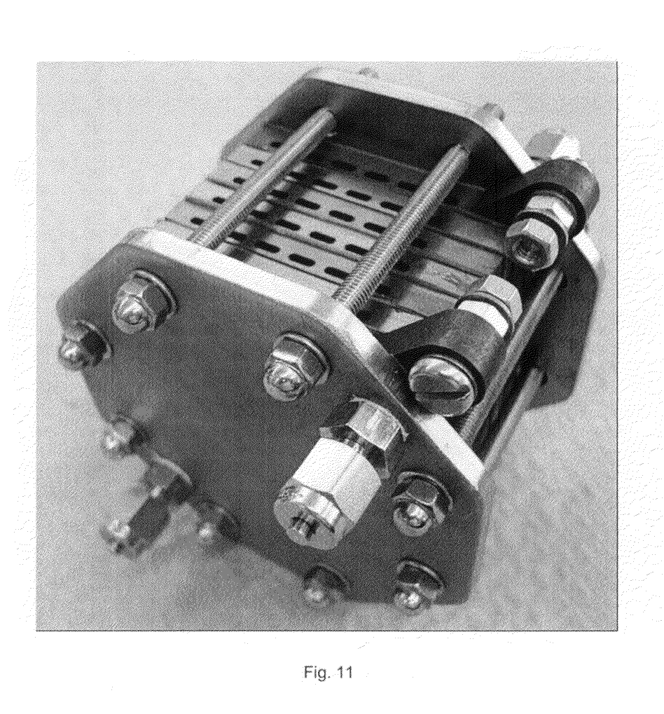

The stack is assembled as schematically shown in FIG. 1. A 3-D view of interconnect, current collector and assembly plate layers only is also shown in FIGS. 9 and 10. In FIG. 1, the stack components are stacked in the following order: the front assembly plate, silicone rubber sheet, negative current collector plate, carbon paper with gas sealing gasket, end interconnect plate (with only hydrogen flow field), MEA with gaskets, bipolar interconnect plate, and keep repeating MEA with gaskets and bipolar interconnect plate, and finally end interconnect plate (with only air flow field), carbon paper with sealing gasket, positive current collector plate, silicone rubber sheet, and end assembly plate. The stack is assembled to achieve effective sealing and electrical contact between different stack components. FIG. 11 illustrates a photograph of an example 6-cell assembled stack.

### Stack Performance

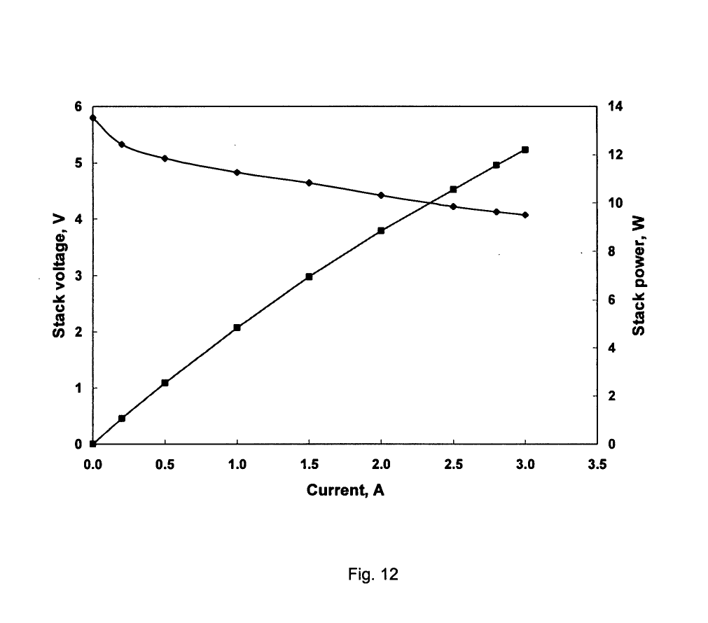

An example stack was tested in a test station on industrial grade hydrogen. FIG. 12 shows typical voltage-current characteristics of the stack. The stack produced a maximum power output of 12.2 Wₑ (4.07V/3 A), which is equal to 81 mW/cm² of power density. The average area specific ohmic resistance calculated from the voltage current curve is 0.40Ω-cm². These operating power densities were obtained with the use of dry industrial grade hydrogen and passive operation of the stack (no forced air supply—the oxygen supply to the cell interface is via oxygen concentration gradient through the side slots in the bipolar interconnect), no hydrogen humidification and cell relying entirely on self humidification, and dead end mode of stack operation with near 100% hydrogen utilisation.

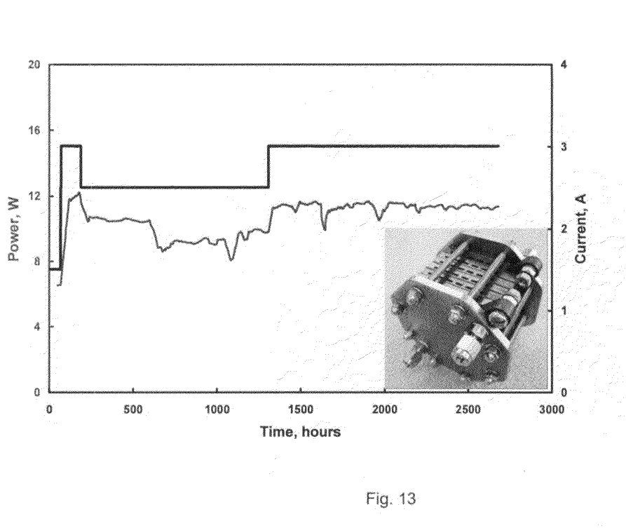

The six cell stack was operated for a period of about 2700 hours as shown in FIG. 13. The stack was initially operated at 2.5 A current for a period of ˜1200 h, and then at 3 A for another 1500 h. The average cell temperature at 2.5 A was 32° C. and at 3 A was 35° C. At 2.5 A, the stack produced power output in the range 10-11 Wₑ, and at 3 A the power output stayed around 12 Wₑ. After 2000 h of operation, the values of voltages of individual cells at 3 A of current load was within the range 0.60 to 0.72V, with average cell voltage of 0.644V.

### Alternative Bipolar Interconnect Plate Design Modifications

In order to reduce the overall size, especially length of the stack, the thickness of the bipolar interconnect plate was substantially reduced in an alternative embodiment. The hydrogen flow field depth was reduced from 1 mm to 0.5 mm (i.e. channels are 1 mm wide and 0.5 mm deep, and ribs are 1 mm wide and 0.5 mm high). The pillars of the air flow field were reduced in height from 3 mm to 2 mm (i.e. the pillars of cross section 2 mm×2 mm are now 2 mm high with 2 mm space between each other). Now, there is a solid graphite thickness of 0.5 mm instead of 1 mm in the previous design, between the lands of air flow field and base of hydrogen flow field channels. This resulted in the final thickness of the plate as 3 mm.

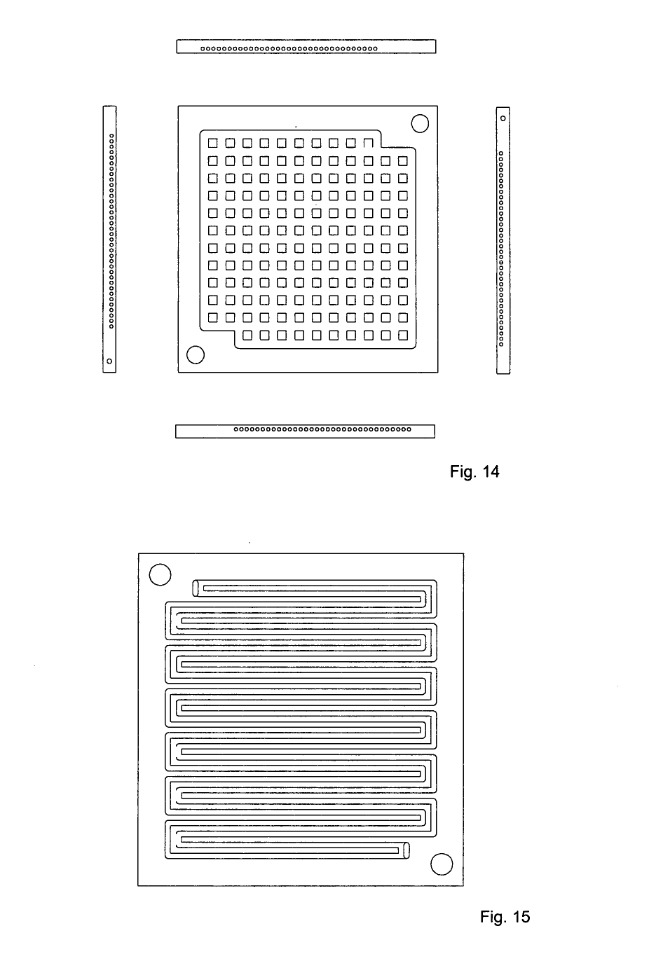

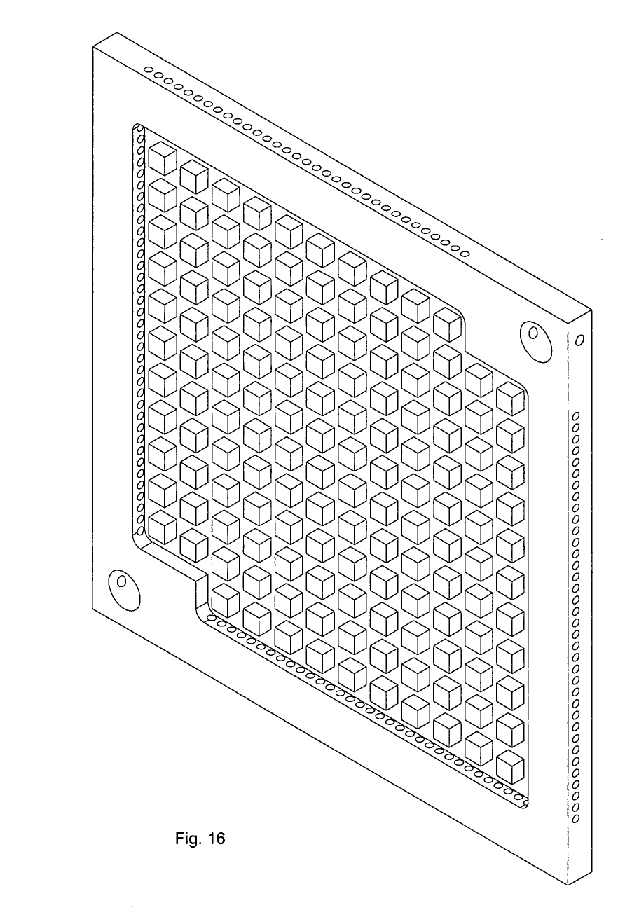

FIG. 14 illustrates a front plan view and a series of side views of the air flow side of the alternative bipolar interconnect plate. FIG. 15 illustrates a plan view of the hydrogen channel side of the 3 mm bipolar interconnect plate and FIG. 16 illustrates a side perspective view of the air breathing side of the bipolar interconnect plate. Due to space constraints on the thickness side of the plate, the slots for self air breathing in the previous design had to be modified to 0.8 mm diameter holes. There are 36 holes on two opposite sides and 33 on the other two sides.

### Interconnect Performance

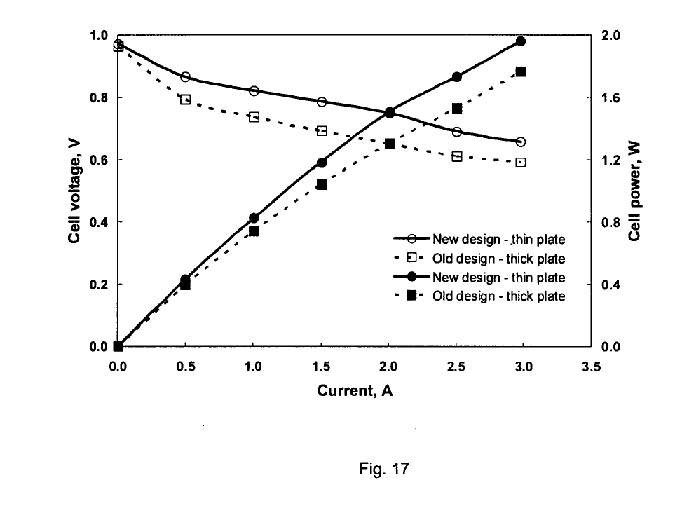

In order to evaluate the new design of the interconnect plate, a 2-cell stack was assembled, with one MEA assembled with a thinner bipolar plate (new design with air breathing holes) and the other with a thicker interconnect plate (old design with air breathing slots). FIG. 17 compares the voltage current characteristics of the two cells. It can be seen that the maximum power output produced by the MEA with thinner bipolar plate is 1.96 W as compared to 1.76 W produced by that of the MEA with thicker bipolar plate. As a further step, using the above thin interconnect design, a six cell stack was constructed, and is presently undergoing evaluation. The stack is presently being operated at 10 W (2.5 A, 4V) of power output.

Although the present invention has been described with particular reference to certain preferred embodiments thereof, variations and modifications of the present invention can be effected within the spirit and scope of the following claims.

We claim:

1. A bipolar interconnect plate for a fuel cell, including:
a first surface having a series of conductive interconnect posts for forming a conductive interconnect for conductively interconnecting, in use, with a cathode surface of a membrane electrode assembly (MEA);
said plate including a series of ridges surrounding said first surface having air access slots therein in fluid communication with said first surface.

2. A plate as claimed in claim 1 wherein said side ridges surround said first surface for, in use, forming a seal against a membrane surface.

3. A plate as claimed in claim 1 wherein said bipolar interconnect plate further includes a second surface including a series of fuel supply channels formed therein, said fuel supply channels mating with an anode surface of a MEA in use to supply a fuel to the surface of said anode.

4. A plate as claimed in claim 1 wherein said plate includes a series of apertures for the transmission of fluid there through.

5. A plate as claimed in claim 1 wherein said plate is formed from fine grain graphite impregnated with a resin.

6. A plate as claimed in claim 1 wherein said plate is formed from a metal or an alloy that has been processed by means of at least one of electroetching, electroplating, stamping or embossing.

7. An air breathing fuel cell including a series of bipolar interconnect plates as claimed in claim 1 interposed and interconnected to a membrane electrode assembly.

8. An air breathing fuel cell as claimed in claim 7 wherein said fuel cell is arranged in a stacked configuration.

9. An air breathing fuel cell as claimed in claim 7 wherein the air is fan fed to said fuel cell.

10. A plate as claimed in claim 1 wherein the plate is formed from two subplates joined together.

11. A plate as claimed in claim 10 wherein the two sub plates are joined together by one of spot welding, or using electrically conducting adhesives or glues.

12. A plate as claimed in claim 10 wherein pins or nails are utilised to form a conductive interconnect between the subplates.

13. A plate as claimed in claim 1 wherein several portions of the plate are fabricated separately and joined to form the interconnect plate.

14. A plate as claimed in claim 1 wherein said plate is formed from a metal that has corrosion protection coating.

15. A plate as claimed in claim 1 wherein the plate is utilised in a multi cell fuel cell array and includes a multi cell interconnect where two or more cells are interconnected in a planar arrangement and subsequently stacked with a number of such planar cell arrays.

16. A plate as claimed in claim 1 wherein the conductive interconnect posts have a cross section that is one of rectangular, circular, hexagonal, elliptical, octagonal.

17. A plate as claimed in claim 1 wherein the air access slots are of different shapes.

18. A plate as claimed in claim 1 wherein the interconnect plate also acts as a current collection plate.

19. A plate as claimed in claim 1 wherein the cross sectional area of each of the conductive interconnect posts is varied in accordance with a predetermined relationship to the size of the interconnect plate.

20. A plate as claimed in claim 1 wherein the size of the air access slots forms a predetermined relationship to the active area of the membrane electrode assembly.
